(19) United States
(12) Patent Application Publication
(10) Pub. No.: US 2026/0086294 A1
(43) Pub. Date: Mar. 26, 2026

(54) Multiplexing High Density Two Dimensional Collimator Array And Its Assembly Method

(71) Applicant: Fuzhou Photop Optics Co., Ltd., Fuzhou (CN)

(72) Inventors: Lei Lin, Fuzhou (CN); Junjie Yao, Fuzhou (CN); Xu Jia, Fuzhou (CN); Guanglong Yu, Fuzhou (CN); Junjie Chen, Fuzhou (CN)

(21) Appl. No.: 18/915,980

(22) Filed: Oct. 15, 2024

(30) Foreign Application Priority Data
Sep. 24, 2024 (CN) 2024113374285

(51) Int. Cl. G02B 6/36; G02B 3/00; G02B 6/27; G02B 27/30

(52) U.S. Cl. CPC G02B 6/3644; G02B 3/0037; G02B 6/2706; G02B 27/30; G02B 2003/0093

(57) ABSTRACT

Embodiments of the present disclosure comprise a two-dimensional collimator array comprising a two-dimensional fiber array and a spacer. Embodiments may also comprise a two-dimensional collimator lens array comprising a two-dimensional collimating meta lens array of meta lenses that can be made from nano structures.

### TECHNICAL FIELD

The present disclosure generally relates to a multiplexing high-density two-dimensional collimator array.

### BACKGROUND

Aspects of the present disclosure relate to a multiplexing high-density two-dimensional collimator array. In this regard, conventional collimator array systems may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims is a multiplexing high-density two-dimensional collimator array.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 is a block diagram illustrating a two-dimensional collimator array, according to some embodiments of the present disclosure.

FIG. 2 illustrates an exemplary arrangement of a two-dimensional collimator array, according to some embodiments of the present disclosure.

FIG. 3 is a flowchart illustrating an assembly method, according to some embodiments of the present disclosure.

### DETAILED DESCRIPTION

The following discussion provides various examples of a system for a multiplexing high-density two-dimensional collimator array. Such examples are non-limiting, and the scope of the appended claims should not be limited to the particular examples disclosed. In the following discussion, the terms “example” and “e.g.,” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “comprises,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Embodiments of the present disclosure may comprise a two-dimensional collimator array comprising a two-dimensional fiber array. Embodiments may also comprise a spacer. Embodiments may also comprise a two-dimensional collimator lens array comprising a two-dimensional collimating meta lens array.

In accordance with various embodiments, the two-dimensional fiber array may comprise a base flange, one or more guide whole array blocks, and a multilayer flat stack. In accordance with various embodiments, the multilayer flat stack may comprise one or more supporting flat sheets and one or more positioning flat sheets.

In accordance with various embodiments, the multilayer flat stack may comprise an integrated flat piece configured to support and position fibers coupled to the two-dimensional collimator array. In accordance with various embodiments, the base flange may be made of a material with a low thermal expansion coefficient. Embodiments may also comprise through-holes in the two-dimensional fiber array that may each be aligned with one meta lens of the two-dimensional collimating meta lens array.

In accordance with various embodiments, the system may comprise a focus lens array. In accordance with various embodiments, each focus lens may be a meta lens. In accordance with various embodiments, the meta lenses may be configured to collimate and/or focus a single wavelength light or a wide band light, and/or to exhibit a large numerical aperture.

In accordance with various embodiments, the meta lenses may comprise a nano structure. Embodiments of the nano structure may be cylinders, tetrahedrons, pyramids, cuboids, prisms, rods, cones and/or any other suitable nano structure. In accordance with various embodiments, the meta lenses may be made from silicon on insulator (SOI).

In accordance with various embodiments, the meta lenses may be configured to provide an achromatic structure. In accordance with various embodiments, the meta lenses may be configured to provide a polarization selection effect. Embodiments may also comprise one or more meta lenses that may be operable to generate vortex light modulation.

In accordance with various embodiments, the two-dimensional collimator array may be configured for use with an optical circuit switch.

In accordance with various embodiments, one or more of the meta lenses may be operable to change the phase of input light at their output, wherein said phase change may be a function of selected dimensions and orientation of nano structures used to form said meta lenses. For example, when a selected shape of a nano structure is a cuboid, changing the height, width, length, and/or angular orientation of the cuboids may change the phase change that a meta lens may produce.

In accordance with various embodiments, the meta lenses may comprise one or more stacked layers of nano structures. For example, it may be advantageous to combine multiple layers of nano structures to obtain desirable optical properties of meta lenses. This may be obtained, for example, by stacking multiple layers of nano structures.

Embodiments of the present disclosure may also comprise a method to assemble a two-dimensional collimator array by stacking a two-dimensional fiber array. with a two-dimensional collimator lens array. Embodiments may also comprise a spacer. Embodiments may also comprise a two-dimensional collimating meta lens array.

In accordance with various embodiments, the method may comprise using a focus lens array. In accordance with various embodiments, each focus lens may be a meta lens.

In accordance with various embodiments, the method may comprise stacking a base flange, one or more guide whole array blocks, and a multilayer flat stack to assemble the two-dimensional fiber array. In accordance with various embodiments, the method may comprise stacking one or more supporting flat sheets and one or more positioning flat sheets to assemble the multilayer flat stack.

In accordance with various embodiments, the method may comprise using an integrated flat piece configured to support and position fibers coupled to said two-dimensional collimator array. In accordance with various embodiments, the system may comprise using a base flange made from a material with a low thermal expansion coefficient.

In accordance with various embodiments, the method may comprise aligning each through-hole of the two-dimensional fiber array with one meta lens of the two-dimensional collimating meta lens array. In accordance with various embodiments, the method may comprise configuring the meta lenses to collimate and/or focus a single wavelength light or a wide band light, or to exhibit a large numerical aperture.

In accordance with various embodiments, the method may comprise using meta lenses made from nano structures. In accordance with various embodiments, the method may comprise using nano structures made in the shape of cylinders, tetrahedrons, pyramids, cuboids, prisms, rods, and/or cones. In accordance with various embodiments, the method may comprise using the meta lenses from silicon on insulator (SOI).

In accordance with various embodiments, the method may comprise using meta lenses to provide an achromatic structure. In accordance with various embodiments, the method may comprise using meta lenses that provide a polarization selection effect. In accordance with various embodiments, the method may comprise meta lenses operable to generate vortex light modulation. In accordance with various embodiments, the method may comprise configuring the two-dimensional collimator array for use with an optical circuit switch.

In accordance with various embodiments, the method may comprise changing the phase of input light at the output of the meta lenses, and wherein the phase change may be a function of selected dimensions of nano structures used to form said meta lenses. For example, when a selected shape of a nano structure is a cuboid, changing the height, width, length and/or angular orientation of the cuboids may change the phase change that a meta lens may produce.

In accordance with various embodiments, the method may comprise stacking one or more layers of nano structures to obtain desirable optical properties of meta lenses.

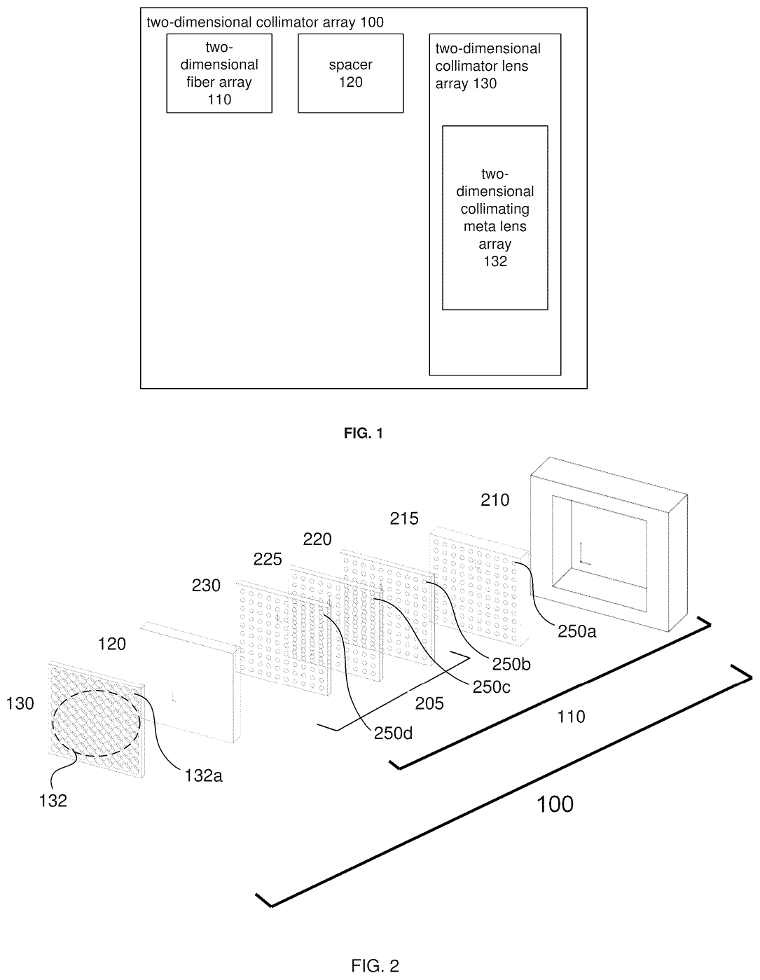

Referring now to FIG. 1, FIG. 1 is a block diagram that describes a two-dimensional collimator array 100, according to some embodiments of the present disclosure. The two-dimensional collimator array 100 may include a two-dimensional fiber array 110, a spacer 120, and a two-dimensional collimator lens array 130. The two-dimensional collimator lens array 130 may comprise a two-dimensional collimating meta lens array 132.

A two-dimensional collimator array 100 may be used to couple a number of optical fibers to some system. To this end, the fibers are arranged, for example, in an N×M dimensional array such as two-dimensional fiber array 110. In the present disclosure, the light from the optical fibers in the array 120 may be directed to a two-dimensional collimator lens array 130. At the two-dimensional collimator lens array 130, the light from the optical fibers may be collimated for further processing. The lenses used in the two-dimensional collimator lens array 130 may be meta lenses.

FIG. 2 illustrates an exemplary arrangement of a two-dimensional collimator array, according to some embodiments of the present disclosure. There is shown a two-dimensional collimator array 100, a two-dimensional fiber array 110, a spacer 120, a two-dimensional collimator lens array 130 comprising a two-dimensional collimating meta lens array 132. In some embodiments, the two-dimensional fiber array 110 may comprise a base flange 210, one or more guide whole array blocks 215, and a multilayer flat stack 205. The multilayer flat stack 205 may comprise one or more supporting flat sheets 220, 225 and one or more positioning flat sheets 230.

In some embodiments, the multilayer flat stack 205 may comprise an integrated flat piece configured to support and position fibers coupled to the two-dimensional collimator array. For example, the exemplary layers 220, 225, 230 may be integrated into a single machined piece.

In some embodiments, the base flange 210 is made of a material with a low thermal expansion coefficient.

In some embodiments, each through-hole of the two-dimensional fiber array 110 is aligned with one meta lens of the two-dimensional collimating meta lens array. FIG. 2 illustrates one exemplary through-hole formed from aligned through-holes 250a, 250b, 250c, 250d that may be aligned with a (meta) lens 132a of the collimating lens array 130.

In some embodiments, the system may comprise a focus lens array (not shown) wherein each focus lens is a meta lens. For example, a focus lens array may be placed before, after, in addition to, or instead of a collimator lens array 130 in the stack forming the two-dimensional collimator array 100.

In some embodiments, the meta lenses 132 may be configured to collimate and/or focus a single wavelength light or a wide band light, or to exhibit a large numerical aperture. This may depend on the physical and selected structure and characteristics of the meta lenses, for example meta lens 132a. In some embodiments, the meta lenses may comprise a nano structure. The nano structures may comprise cylinders, tetrahedrons, pyramids, cuboids, prisms, rods, and/or cones, but may include any nano structure that exhibits desirable properties for a desirable function of the meta lens when interacting with the light delivered through an optical fiber. The meta lenses may be fabricated using silicon on insulator (SOI), for example. The meta lenses may be configured to provide an achromatic structure, to provide a polarization selection effect, or generate vortex light modulation, for example.

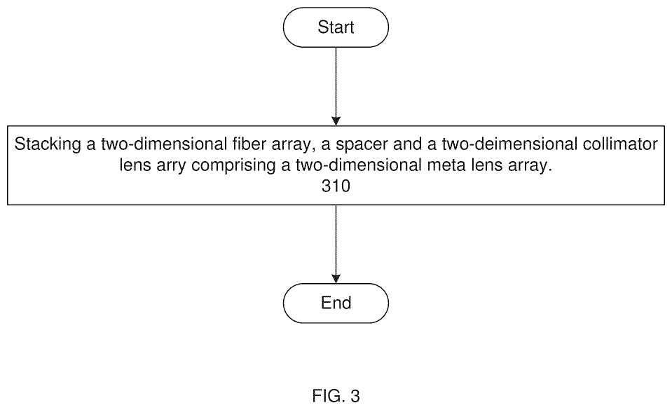

FIG. 3 is a flowchart that describes a method, according to some embodiments of the present disclosure. At 310, a method of assembly of a two-dimensional collimator array (e.g., 100) may comprise a stacking of a two-dimensional fiber array (e.g., 110), a spacer (e.g., 120) and a two-dimensional collimator lens array (e.g., 130) that may comprise a two-dimensional collimating meta lens array (e.g., 132).

In some embodiments, with reference to both FIG. 2 and FIG. 3, at 310, the method may include stacking a base flange (e.g., 210), one or more guide whole array blocks (e.g., 215), and a multilayer flat stack (e.g., 205) to assemble the two-dimensional fiber array (e.g., 110). In some embodiments, at 320, the method may include stacking one or more supporting flat sheets (e.g., 220, 225) and one or more positioning flat sheets (e.g., 230) to assemble the multilayer flat stack (e.g., 205).

In some embodiments, the method may comprise using meta lenses from nano structures, for example in the shape of cylinders, tetrahedrons, pyramids, cuboids, prisms, rods, cones and/or any other suitable nano structure, to form the collimating lens array 132.

The present disclosure comprises reference to certain examples; however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will comprise all examples falling within the scope of the appended claims.

What is claimed is:

1. A two-dimensional collimator array comprising
a two-dimensional fiber array;
a spacer; and
a two-dimensional collimator lens array comprising
a two-dimensional collimating meta lens array.

2. The system of claim 1, wherein said two-dimensional fiber array comprises a base flange, one or more guide whole array blocks, and a multilayer flat stack.

3. The system of claim 2, wherein said multilayer flat stack comprises one or more supporting flat sheets and one or more positioning flat sheets.

4. The system of claim 2, wherein said multilayer flat stack comprises an integrated flat piece configured to support and position fibers coupled to said two-dimensional collimator array.

5. The system of claim 2, wherein said base flange is made of a material with a low thermal expansion coefficient.

6. The system of claim 1, wherein each through-hole of said two-dimensional fiber array is aligned with one meta lens of said two-dimensional collimating meta lens array.

7. The system of claim 1, comprising a focus lens array wherein each focus lens is a meta lens.

8. The system of claim 1, wherein said meta lenses are configured to collimate and/or focus a single wavelength light or a wide band light, or to exhibit a large numerical aperture.

9. The system of claim 1, wherein said meta lenses comprise a nano structure.

10. The system of claim 9, wherein said nano structure comprises cylinders, tetrahedrons, pyramids, cuboids, prisms, rods, and/or cones.

11. The system of claim 1, wherein said meta lenses are made from silicon on insulator (SOI).

12. The system of claim 1, wherein said meta lenses are configured to provide an achromatic structure.

13. The system of claim 1, wherein said meta lenses are configured to provide a polarization selection effect.

14. The system of claim 1, wherein one or more of said meta lenses are operable to generate vortex light modulation.

15. The system of claim 1, wherein said two-dimensional collimator array is configured for use with an optical circuit switch.

16. The system of claim 1, wherein one or more of said meta lenses are operable to change the phase of input light at their output, wherein said phase change is a function of selected dimensions and/or orientation of nano structures used to form said meta lenses.

17. The system of claim 1, wherein one or more of said meta lenses may comprise one or more stacked layers of nano structures.

18. A method to assemble a two-dimensional collimator array by stacking:
a two-dimensional fiber array;
a spacer; and
a two-dimensional collimator lens array comprising
a two-dimensional collimating meta lens array.

19. The method of claim 18, comprising stacking a base flange, one or more guide whole array blocks, and a multilayer flat stack to assemble said two-dimensional fiber array.

20. The method of claim 19, comprising stacking one or more supporting flat sheets and one or more positioning flat sheets to assemble said multilayer flat stack

21. The method of claim 19, comprising using an integrated flat piece configured to support and position fibers coupled to said two-dimensional collimator array, for stacking in said multilayer flat stack.

22. The system of claim 19, comprising using said base flange made from a material with a low thermal expansion coefficient.

23. The method of claim 18, comprising aligning each through-hole of said two-dimensional fiber array with one meta lens of said two-dimensional collimating meta lens array.

24. The method of claim 18, comprising using a focus lens array wherein each focus lens is a meta lens.

25. The method of claim 18, comprising using meta lenses operable to collimate and/or focus a single wavelength light or a wide band light, or to exhibit a large numerical aperture.

26. The method of claim 18, comprising using said meta lenses made from nano structures.

27. The method of claim 26, comprising using said nano structures made in the shape of cylinders, tetrahedrons, pyramids, cuboids, prisms, rods, and/or cones.

28. The method of claim 18, comprising using meta lenses made from silicon on insulator (SOI).

29. The method of claim 18, comprising using meta lenses operable to provide an achromatic structure.

30. The method of claim 18, comprising using meta lenses operable to provide a polarization selection effect.

31. The method of claim 18, comprising using one or more meta lenses operable to generate vortex light modulation.

32. The method of claim 18, comprising configuring said two-dimensional collimator array for use with an optical circuit switch.

33. The method of claim 18, comprising changing a phase of input light at the output of one or more of said meta lenses, wherein said phase change is a function of selected dimensions and/or orientation of nano structures used to form said meta lenses.

34. The method of claim 18, comprising stacking one or more layers of nano structures to form one or more of said meta lenses.
